(19) United States
(12) Patent Application Publication
(10) Pub. No.: US 2009/0300848 A1
(43) Pub. Date: Dec. 10, 2009

(54) EPOXIDE-BASED TANNAGE SYSTEM

(75) Inventors: Stuart Booth, Northampton (GB); Richard Heath, Loughborough (GB); Ying Di, Middlesex (GB)

Correspondence Address: OCCHIUTI ROHLICEK & TSAO, LLP, 10 FAWCETT STREET, CAMBRIDGE, MA, 02138, US

(73) Assignees: BLC LEATHER TECHNOLOGY CENTRE LTD, NORTHAMPTON (GB); UNIVERSITY OF LOUGHBOROUGH, LEICESTERSHIRE (GB)

(21) Appl. No.: 12/293,500

(22) PCT Filed: Mar. 26, 2007
(86) PCT No.: PCT/GB2007/050154

§ 371 Date: May 11, 2009

(30) Foreign Application Priority Data
Mar. 27, 2006 (GB) 0605895.2

(51) Int. Cl. C14C 3/08

(52) U.S. Cl. 8/94.33

(57) ABSTRACT

Leather is prepared by tanning animal skins with a poly(glycidylamine) such as trigycidyl isocyanurate. After retannage with vegetable tannins, it is possible to obtain both a mineral-free and aldehyde-free white leather having Ts >85° C. and suitable for automotive internal trim and a mineral-free and aldehyde-free high thermal stable organic leather having Ts >100° C. and suitable for shoe production.

### FIELD OF THE INVENTION

This invention relates to a method of tanning hides and skin, and also to a method of retanning hides and skins. In particular, it relates to the use of a specific class of epoxides based on glycidyl amines as novel tanning agents, which may be combined with retannages, especially with vegetable tannins.

### BACKGROUND OF THE INVENTION

Chromium salts tanning has been prevailing in leather making since the 18th centuries, because of their low cost, high efficiency and convenience in operation, versatility of resulting leathers, and most importantly giving leather high hydrothermal stability. Excellent hydrothermal stability, also known as shrinkage temperature (Ts), at 120° C. are obtained with chromium salt tannages, and as such indicate a complete tannage degree and excellent physical/mechanical/chemical properties.

However, it is getting increasingly difficult to comply with ever emerging regulations, with respect to the chromium compound usage in the workplace, contamination of effluent, and disposal of chromium-containing wastes. Other metal ion compounds, such as aluminium (III), titanium (IV) and zirconium (IV) may also invoke similar problems and so restriction in the future, if they were to be exploited as chromium replacements in tanning. Thus, due to the perceived environmental and commercial advantages in utilising organic (mineral-free) products, the leather industry has been increasingly encouraged to examine alternative chemistry and process technologies. Currently, the driving force particularly comes from the automotive industry, while other leather users are beginning to examine the potential of chrome-free or even mineral-free alternatives.

Existing commercial, organic primary tanning materials tend to yield leathers with low shrinkage temperatures e.g. Ts ˜80-85° C., including vegetable tannins, oxazolidines, phosphonium salts, melamine resins, glutaraldehyde; many of these are aldehydic in nature. Glutaraldehyde or modified glutaraldehyde is the most commercially used organic tanning agents but usually give positive results with testing for residual formaldehyde. The issue of formaldehyde is critical: current legislation imposes a very strict limit of 10 ppm content for automotive leather which is difficult to achieve. Glutaraldehyde-tanned leather also shows the drawback of the “shade effect” after dyeing. It also requires an increase of 10 to 15% retannage materials and 12 to 15% fatliquor in post tannage process (cf. chromium tannages). The use of most aldehydes in processing presents potential health and safety risks to operators. Furthermore, glutaraldehyde-based tanning agents can cause problems within the biological effluent treatment plants where the aldehyde can act as an effective biocide; moreover, as chemical uptake is incomplete, the COD of the effluent is 50% greater, cf. chromium tannage treatment. Therefore there is a need for novel organic tannage technology which provides a cleaner processing route and better product properties.

Epoxy groups have a high chemical reactivity with a number of the functional groups present on protein structures. As reactive prepolymers (or oligomers), many epoxies have some distinct advantages over other reactants, including:
reactive to a wide range of functional groups under suitable conditions;
variety of molecular structures, which may be tailored for specific application methods and/or end uses;
polymerisation, addition or crosslinking by forming covalent bonds;
relatively low toxicity, (cf. aldehydes);
many, freely available in relatively large qualities commercially.

Multiple functional epoxides are known to have the crosslinking ability with animal skin collagen molecules. The reactions mainly occurs between epoxide and basic amino acid residues (i.e. primary amines) of collagen. The reactions involve nucleophilic attack by an epoxy ring at multiple sites with ring opening, here on the peptides side chain including the lysine, hydrolysine, tryrosine and methionine sites, and by condensation or polyaddition reactions to form stable covalent linkages. It has been found that epoxies are capable of several reactions with collagen, and so work as multifunctional curing agents.

However, compared to the current, common used organic tanning agents, e.g. glutaraldehyde, their tanning effects and reaction rates are too low to be accepted in industrial application.

The objects of the present invention include one or more of:
to provide a novel primary tanning agent, as an aldehyde alternative.
to provide a method of tanning which will yield a mineral-free and aldehyde-free organic leather, and so be an acceptable chromium tannage replacement.
to provide an organic leather with high stability in subsequent manufacturing processes and in service, including hydrothermal stability, thermal degradation stability, enzymatic digestion stability; and improved dyeability with good strength and handle.
to provide a leather suitable used in high grade automotive internal trim, e.g. seat covers.
to provide a leather suitable used in a wide leather sectors, particularly in shoe manufacturing industry, for instance in “environmentally friendly” products.

### SUMMARY OF THE INVENTION

The studies of the present inventors have revealed that a successful tannage requires much more than the simple introduction of crosslinkings. The number, size and location of the crosslinks as well as any change in the electrostatic charge and hydrophilic/hydrophobic character of the collagen, all play a part in determining the properties of the resulted leather.

The present invention is based on the finding that poly(glycidylamines) are able to provide a much improved tanning ability compared to epoxides previously cited in the literature, and thereby produce high performance leather.

Accordingly the present invention provides a process for tanning leather in which the tanning agent is a poly(glycidylamine).

Suitably the poly(glycidylamine) has a structure of general formula (I)

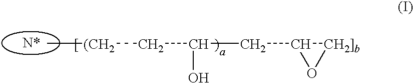

in which N* is nitrogen or a moiety containing at least 2, and preferably 3, nitrogen atoms, a is 0, 1 or 2 and b is at least 2, preferably 3.

Preferably N* is a nitrogen containing heterocyclic moiety, especially a triazine.

A preferred compound of general formula (I) is trigycidyl isocyanurate (also known as TGIC), which is commercially available from Ciba under the trade name TEPIC.

The tanning process may also be carried out using an urea adduct of the compound of general formal (I).

Suitably the process is carried out by treating animal skins or hides with an aqueous solution of a compound of general formula (I), typically by drumming the hides or skins in a water bath containing the compound of general formula (I).

Preferably the hide and skins which have been tanned with a compound of general formula (I) are subjected to retannage using vegetable tannins, such as Tara and especially Mimosa extracts.

Further features and advantages of the present invention will be apparent from the following more detailed description and the accompanying drawings.

### BRIEF DESCRIPTION OF THE DRAWINGS

FIG. 1 shows TGA thermograms of TGIC-tanned leather, compared with untanned skin and glutaraldehyde-tanned leather, (carried out in an air atmosphere);

FIG. 2 is a structure diagram showing polymerization in situ via pendant epoxy groups of tanned collagen with polyphenols (vertical wavy lines represent collagen-solid lines show covalent bonds between collagen and tannins—broken lines show hydrogen bonds between collagen and tannins);

FIGS. 3a, 3b, 3c and 3d are histograms showing respectively the strength, elongation, softness and toughness of TGIC-tanned leather with and without mimosa retannage;

FIG. 4 is a structure diagram of two different type of polyphenols, where the arrows indicate the epoxy reaction sites

### DETAILED DESCRIPTION OF THE INVENTION

TGIC is a tri-functional polyepoxide having the structure

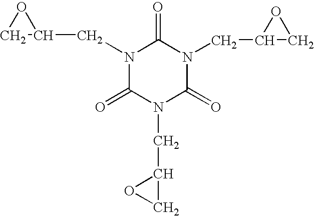

By having an aromatic-like, heterocyclic triazine nucleus, it is believed to impart a network structure into the protein during tanning, giving better thermal stability. It also has some, if limited, solubility in aqueous phase (10 g/l, 25° C.), which is required in many types of collagen treatment. In comparison, for example, the commonly used bisphenol A type aromatic epoxies, novolak type aromatic epoxies and cycloaliphatic epoxies have considerable hydrophobic character (i.e. water insolubility), and therefore are not suitable for conventional leather tanning systems in which aqueous phase is required.

Because of the limited solubility of the proposed tanning agents, it may be desirable to add buffer salts to the tanning bath to help solubilise the glycidylamine. However, in practice, it is usually possible to add the product directly to the float (without premixing) when using drum processing, allowing the mechanical action to ensure that the product is dissolved and taken up gradually by the hides.

The tanning procedure may be preceded by standard beamhouse processing, for example soaking, liming, followed by deliming to around pH 8.5. However, due to potential salt (NaCl) intolerance of the epoxy tanning material, it may be advisable to omit the traditional stage of pickling in acid and salt, so that the tannage is carried out after the deliming and bating.

In the present invention, TGIC can achieve similar or higher degrees of tannage as glutaraldehyde, under industrially acceptable tanning conditions. Preferable process conditions are: offer 2 to 15% by weight, pH 7-10, temperature 30-50° C. For example in typical processing at pH 9.2, a 5% offer of TGIC promotes a significantly rise in Ts to 80° C., while at about 10% the maximum effect was found to give a Ts value greater than 85° C. The leather obtained is odorless, lightfast white, firm and with some rigidity, compared to a glutaraldehyde counterpart.

The physical, mechanical and biochemical properties of TGIC-tanned leather in comparison with skin and glutaldehyde-tanned leather (air dried leather without any post tannage treatment) are shown in Table 1 below.

TABLE 1

| | Untreated | TGIC | GA |
|---|---|---|---|
| | Skin | tanning | tanning |
| Appearance | — | White | Pale Yellow |
| Grain | — | Fine | Slightly Tight |
| Thickness Adding - % | — | 57 | 71 |
| Tensile Strength at Break - MPa | 3 | 17 | 10 |
| Elongation at Break - % | 78 | 101 | 132 |
| Low Strain Modulus - Mpa | 9 | 3 | 1.5 |
| High Strain Modulus - MPa | 72 | 32 | 18 |
| Ts - ° C. | 63 | 85 | 78 |

Enzyme digestion:

| | | | |
|---|---|---|---|
| Trypsin | 28 | 1 | 12 |
| Collagenase | 100 | 2 | 10 |
| Pepsin | 62 | 3 | 4 |

Apart from hydrothermal stability (determined by a modified differential scanning calorimetry method, DSC), the characterization of TGIC-tanned leather in Table 1 includes thermal stability (TGA), basic mechanical properties and enzyme degradation resistances. These properties are used in screening leathers for automotive internal trim, which can be subjected to surprisingly high temperatures when a vehicle is in direct sunlight, particularly to the tops of the rear seats in cars. Such leather is likely to suffer risk from chemical and biochemical damage through the action of perspiration or vehicle cleaning agents, etc. The dyeability of the TGIC-tanned leather has also been investigated.

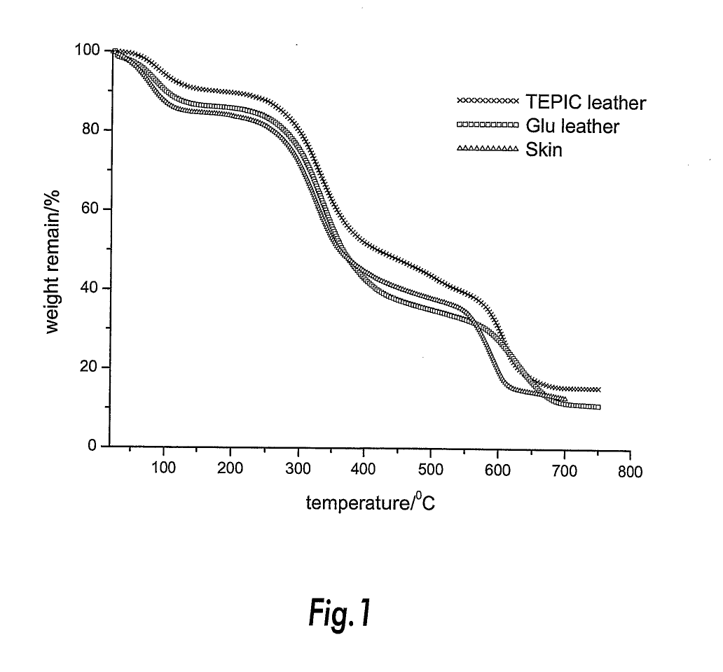

The TGIC leather showed a better heat resistance than either the untreated skin or the glutaldehyde-tanned leather. As shown in FIG. 1 of the accompanying drawings, the thermal degradation properties of untanned skin, glutaraldyde-tanned leather and TGIC-tanned leather, all initiated between 200 to 230° C., which is the typical degradation temperature range for protein polypeptides. There are similarities in comparing the thermograms of untanned skin and glutaraldehyde-tanned leather, while that for TGIC-leather indicates there is apparently higher weight retained over the whole temperature range of test.

Thermal decomposition can be divided into two stages. The maximum loss rate occurs between 280 to 350° C. for skin and glutaraldehyde leather: at 300° C. there is about a 30% weight loss, increasing to 40% at 350° C. In comparison, TGIC leather shows respectively weight losses of 20% and 25%. These data suggests that collagen is covalently crosslinked by TGIC, exhibiting better thermal stability. The improvement of thermal degradation resistance of collagen, is thought to be due to the introduction of a rigid heterocyclic backbone into the polypeptide macromolecular network. This, combined with three-dimensional linkages, would lead to a more thermally stable collagen structure. It also anticipated that the tanning materials may have introduced an additional flame retarding ability to the final leather, because of the N-rich chemical backbones.

The resistance of TGIC tanned leather to enzymes digestion is shown in Table 1: these data are based on the results of trypsin, collagenase and pepsin tests, with comparisons with untanned skin and glutaraldehyde-tanned leather. Enzyme degradation of collagen materials is dependent on, and determined by its helical integrity, the degree of crosslinking and the availability of cleavage sites. Trypsin, an alkaline (pH 8) proteolytic enzyme, breaks down protein peptide bonds at the basic amino acid residues, (i.e. at the lysine and arginine sites). Collagenase digests native collagen in the triple helix region by hydrolysis of the peptide bond at pH 7. Pepsin is most efficient in cleaving bonds involving the aromatic acids such as tyrosine at pH 1 to 3.

All the tannage/crosslink systems will reduce enzyme digestion, while epoxy promotes particularly high stabilization to skin collagen, regardless whether hydrolysis conditions are acidic or basic. This beneficial effect is thought to be related to the numbers of multiple reaction sites on the collagen molecules during tanning. The rigid, planar symmetric heterocyclic nucleus is thought likely to create tighter molecular packing in the collagen, so making the otherwise active sites, less accessible.

TGIC-tanned leather showed good dye absorption and dyeability under normal conditions. As shown in Table 2 below, the residual dye concentration was found to be only half of that of a glutaraldehyde control, while fixation can be carried out at higher pH (6 to 7), instead of the acidic conditions conventionally used; this could be an advantage by avoiding collagen fibres degradation in long term ageing. Apart from the possibility of the collagen esterification mechanism, it is also proposed that an additional fixation ability for the dye comes from the remaining free epoxy groups, which are likely to exist in pendent form in the collagen network. These may undergo nucleophilic condensation with the amine or the phenolic hydroxyl groups of the dye molecules, during the dying conditions used. The amide skeleton itself of the epoxy structure appears to have a weakly positive electronic centre, and so be able to adsorb the dye anion.

TABLE 2
The residual, unfixed dye (Napthol blue black)
at the penetration and fixation stages

| Dye concentration (% wt) | Glutaraldehyde | | TGIC | |
|---|---|---|---|---|
| 0.5 | pH 7 | 11.6% | pH 8 | 4.9% |
| 0.25 | pH 7 | 6.4% | pH 8 | 3.3% |
| 0.5 | pH 5 | 1.5% | pH 5 | 1.0% |
| 0.25 | pH 5 | 1.4% | pH 5 | 0.7% |

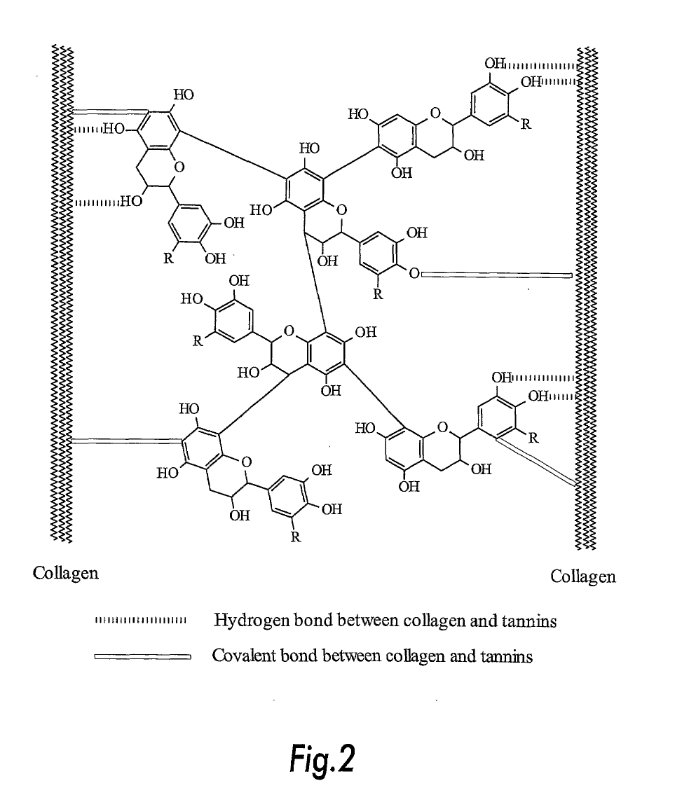

Retannage is a stage in leather making carried out after primary tannage process, the main purpose of which is to enhance the physical character, handle and aesthetic properties of the leather, rather than raising shrinkage temperature further. Commercial automotive leather usually is produced by glutaraldehyde primary tannage and followed by 10% tara tannin retannage, this treatment imparts the dimensional stability, fullness, resilience of the final leather. However, for TGIC-tanned leather, suitable retannages based on organic chemicals have been found able to further improve the hydrothermal stability as well as enhance these other physical properties. The fundamental mechanism of this secondary process is thought to be due to polymerization in situ via pendant epoxy groups. The trifunctional epoxide TGIC, is most likely to introduce a certain amount of pendant epoxy groups fixed to the collagen molecules, during the primary tannage stage when most of reactive groups have participated the crosslinking reaction; these free pendant epoxy groups keep their reactivity under suitable conditions and for some time (see FIG. 2). Thus, they supply the later polymerization reactive sites and so opportunities for interaction with a wide range multiple reactive functional chemicals or epoxy curing agents, i.e. polyamines, polyphenols, polycarboxyls, polyhydromethols (either synthetic or natural derived), within the already partially, crosslinked collagen matrix. This may lead in secondary treatment (i.e. retannage), an overall, more stable covalently bonded network, therefore, giving a better service performance as a leather; e.g. higher thermal stability and extra fullness with resilience. Meantime, the newly incorporated segments derived from the second stage crosslinking could be exploited to bring versatile features to the final leather, dependent on to the various chemical backbones selected. Since hydrothermal stability of leather has is positively affected by use of the TGIC primary tannage, the second stage polymerization/cross-linking, during retannage, can be carried out at higher processing temperatures, above 50° C., to promote the reactions—primary tanning by TGIC imparting better thermal stability to the protein structure.

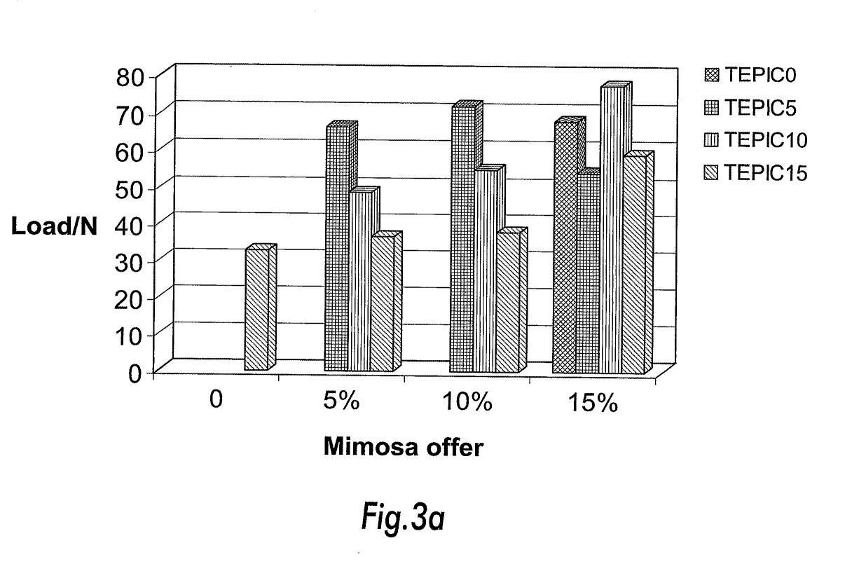

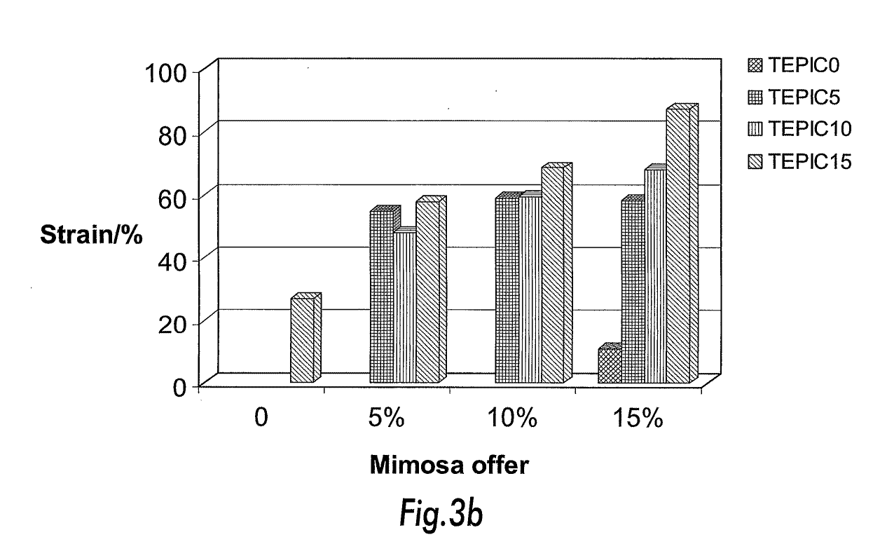

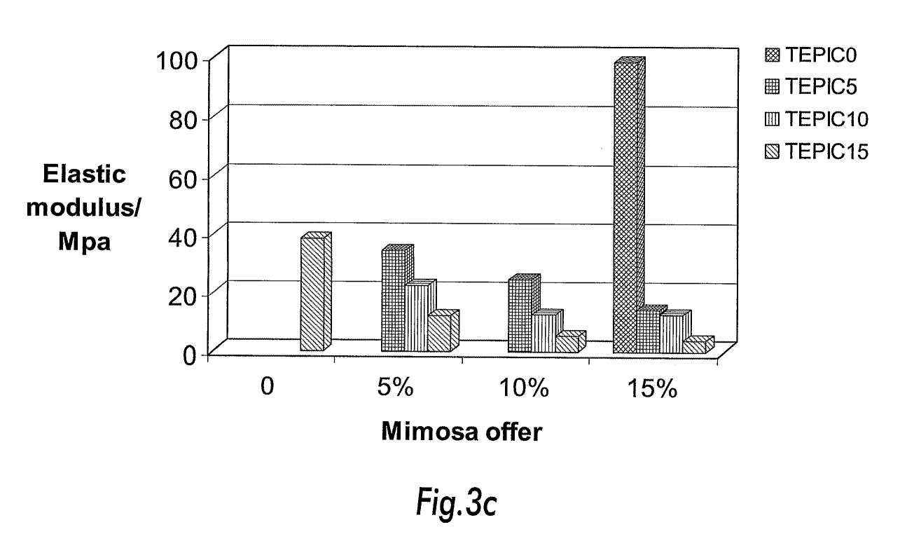

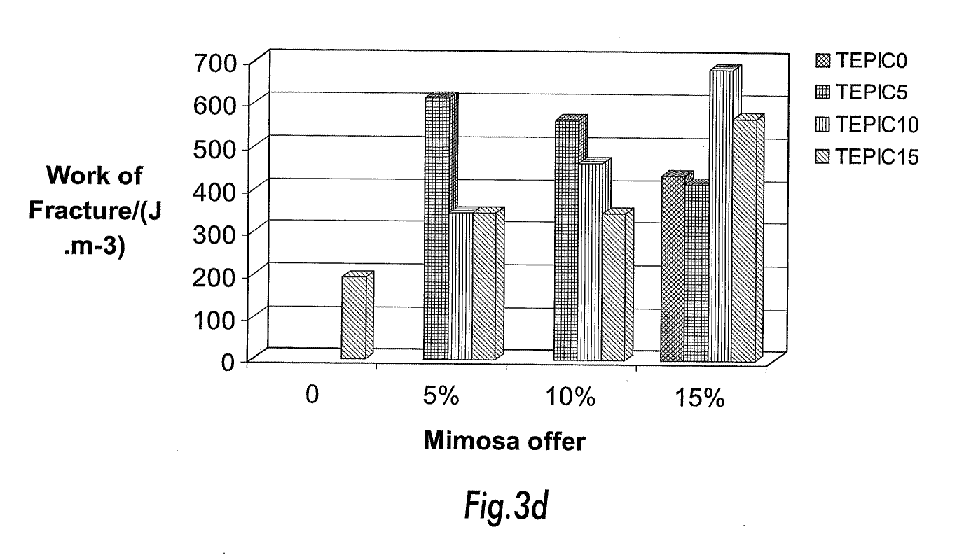

Condensed tannins such as mimosa extract has been found to be an effective retanning agents for TGIC tannage. The preferable offer is 5 to 15% by weight, with processing time of 10 to 15 hr, at under 50 to 60° C.: the Ts of leather was observed to rise to between 104 to 106° C. The leather obtained was of a light brown colour (but stable with sun light), with a fine grain, and it was quite full, resilient, particularly flexible even without fatliquoring or slightly fatliquored. By investigating of strain-stress behaviour of the resulting leather, it was found that the mimosa retannage had much improved the tensile strength, elongation, softness and toughness with thickness; see FIG. 3 of the accompanying drawings.

These properties may be variable, depending on the amounts used of retannage materials. However, it is apparent that mimosa retannage does act differently from the conventional vegetable tanned materials; these types of leather are typically rigid, hard, handless, dark in colour, with a rough grain and low Ts (˜80° C.). In fact, these leathers cannot be used in automotive trim nor in other areas, such as shoe uppers, where conventional shoe lasting demand higher thermal stability.

Using the more common retannage system, hydrolysable tannin Tara extract, with TGIC-tanned leather, a pale yellow leather resulted which did not discolour in sunlight. This leather is similar to the conventional automotive leather prepared by glutaraldehyde tan followed by Tara retan, except for a lower thickness addition. The final shrinkage temperature was in the range of 86 to 90° C., which had slightly increased with retannage, and allowed it to be acceptable for automotive application. The leather thickness adding effect (i.e. a material bulking effect occurring in most tanning processes), is also not so significant as that produced by the same amount of Mimosa.

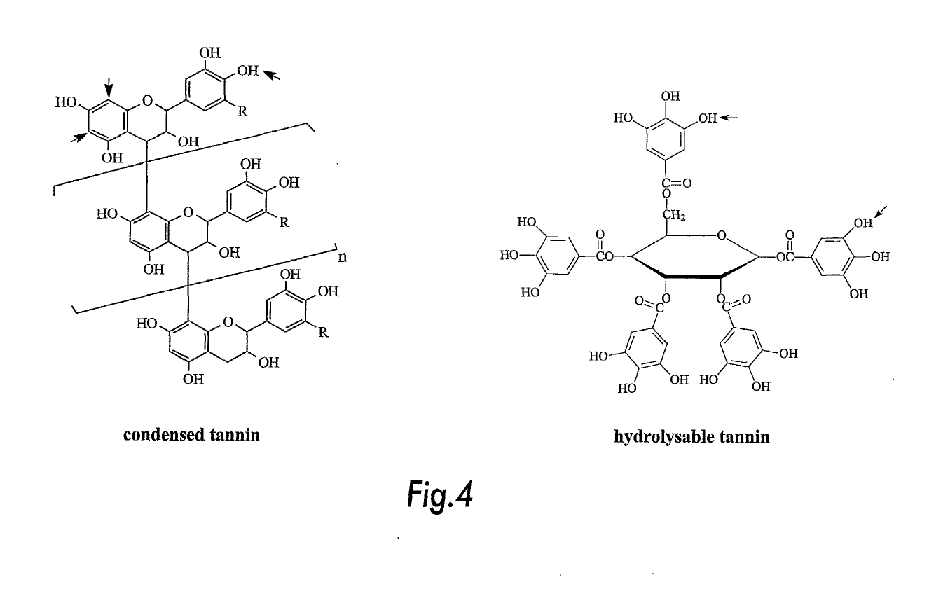

The different retannage effects of both vegetable tannins examined, are due to their chemical structures which determine the potential for polymerization activity towards an epoxy ring—see FIG. 4 of the accompanying drawings. Vegetable tannins are natural polyphenols which are derived from plant extracts, and can be divided into two categories according to their molecular structure features:
1. hydrolysable tannins: represented by tara tannin, gallotannin, valonia tannin and chestnut tannin;
2. condensed tannins; represented by Mimosa tannins, tea tannin, quebracho tannin and gambier tanning.

Hydrolysable tannins have a carbohydrate core with pendant esterified acid, while condensed tannins are polyflavenols. Condensed tannins show greater a reactivity with epoxy groups than hydrolysable tannins under the retannage conditions probably due to two reasons:
1. Both polyphenols show typical usual phenolic properties under epoxy attack, by nucleophilic addition (i.e. the typical epoxy resin reaction), to form ether bond bridges with the pendent epoxy groups on tanned collagen. This condensation reaction occurs at basic pH (9) when the phenolic groups are ionized. However, for condensed tannins, extra reaction sites exist on the flavenol A rings, such as the active hydrogen of C6 or C8, which have strong nucleophilic character compared to the ionized phenol. So nucleophilic substitution by the epoxy group can take place at neutral pH and with higher conversion rates.
2. Both tannins are weak acids with strong buffering ability in nature, while the hydrolysable tannins are more acidic than condensed tannins. The pH of tara or mimosa are 3.5 and 5.5 respectively, so that they will reduce the pH of retannage systems to 5.5 and 7.5, respectively. As the polymerization between polyphenol and epoxy tanned leather is accelerated under basic conditions, it is naturally to think condensed tannin give a higher degree of reaction.

Apart from the basic types of tannins, the molecular size, molecular weight dispersion and spatial conformations are influential factors which decide the properties of the final leather. For instance, mimosa tannin and tea tannin have a very similar structures although differ in degree of polymerization, the former is 5 and the latter is 2; the Ts values resulting are 104 and 96° C. respectively. Therefore, it is proposed that the larger molecule of tannin is preferred in retannage, because of its interaction with the free, pendent epoxy groups introduced during the initial tanning process.

The tanning and retanning process sequence is also an important factor in leather properties. We have found that a TGIC-tannin tannage system preferably follows a specific reaction order to achieve best properties: epoxy tan first, vegetable tan second. Reversing the order is likely to in inferior leather which shows a lower Ts and strength and fullness. This is contrary to the conventional vegetable tannin-aldehyde (including oxazolidine) combination tannage or the vegetable-aluminium combination tannage. The difference in chemical reactivities of epoxy and aldehyde probably is the main reason for this. In addition to the process order variation, vegetable tannin offer ranges are quite different. For all the conventional vegetable tannin-based tannage, a 50% or more tannin offer is usually required to get fully penetration of the leather structure, because of tannin's strong collagen binding property, thus imparting to the leather an unique “vegetable-tan” character, which is not suitable for every occasion. However, in TGIC-tannin system, as collagen fibres have been fixed during the epoxy primary tannage, during retannage tannin molecules probably find it easier to penetrate the leather's structure, with 5 to 10% tannin being enough to distribute evenly through the whole leather cross section within a few hours. On completion of this retannage polymerization, shrinkage temperature >100° C. are achieved, with the leather having a chromium tan-like character: therefore it can be used in a wide application range.

In theory, the copolymerization of polyphenols by epoxy-tanned leather is promoted under basic pH and high reaction temperature conditions. However, basic media (when pH>8) will cause the ionization of phenol groups and therefore reduce the uptake of polyphenol into the collagen. Further, higher pH conditions will also promote the oxidation of phenol, which will bring a darkening of colour to the leather. Thus basification of the reaction mass is not preferable as a means of accelerating retannage; instead an increase of the retannage liquid temperature by a reasonable amount is preferred, e.g. to between 55 to 60° C. In practice, the weakly acidic tannin retannage will simultaneously brings down the high pH of TGIC tanned leather, thus ideally make it suitable to post-tannage treatment, without the need to adjust the pH.

The procedures of the invention are further illustrated in the following Examples.

### Example 1

Trials were carried out on 5 kg pieces fresh hides (no salt preservation) to reduce the chloride ions present in the process. Standard beamhouse processing sequence was followed through soaking, liming, to open the structure and remove hair, followed by deliming to pH 8.5.

To avoid possible salt intolerance of the epoxy tanning material the traditional stage of pickling in acid and salt was omitted and the tannage carried out after the deliming and bating. Thorough deliming was ensured by intermittent overnight running at pH 8.5 checking the cross-section using phenolphthalein. Conventional bating was carried out at 35° C. and the hides washed prior to the addition of the TGIC tanning material (10%). TGIC was added directly to the float within the drum (without premixing) allowing the mechanical action to ensure that the product was dissolved and taken up gradually by the hides. As the shrinkage temperature increased, due gradual uptake and cross-linking with the TGIC the temperature of processing was gradually increased, ensuring that it was always at least 20° C. below the shrinkage temperature.

The process was again run intermittently overnight to ensure completion of the tannage. Retannage and fatliquoring was carried in a conventional way using 15% Mimosa.

### Example 2

Further trials were carried using limed split hides as a starting raw material. On the trial above excess tanning material was found in the exhaust float, so the overall TGIC offer was reduced from 10% to 8%. The amount of water was also increased during the last addition of TGIC from 50% to 200% to assist the solubility and ensure less was left unused. The same procedure as Example 1 was followed, including omitting the pickling step to reduce the possibility of salt affecting the TEPIC uptake.

After tanning the sample was cut in half and processed through a modified retanning and fatliquoring sequence. To assist the penetration of the different retannage systems sodium bicarbonate was introduced to ensure thorough netralisation. One retannage used a natural mimosa product and the other was based on a synthetic condensation product.

1. A process for tanning leather in which the tanning agent is a compound of general formula (I) 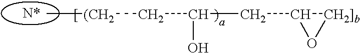
in which N* is nitrogen or a moiety containing at least 2 nitrogen atoms, a is 0, 1 or 2 and b is at least 2.

2. A process according to claim 1 in which animal skins or hides are tanned by contact with an aqueous solution of the compound.

3. (canceled)

4. A process according to claim 1 in which N* is a nitrogen containing heterocyclic moiety.

5. A process according to claim 1 in which trigycidyl isocyanurate is used as the tanning compound.

6. A process according to claim 1 in which the tanning compound is a urea adduct of the poly(glycidylamine).

7. A process according to claim 1 further comprising retannage using synthetic or natural polyphenols, polyamines, polycarboxyls or polyhydromethols.

8. A process according to claim 7 in which the polyphenols used include condensed tannins.

9. A process according to claim 8 in which the condensed tannins comprise mimosa extract.

10. A mineral-free and aldehyde-free white leather having Ts >85° C. and suitable for automotive internal trim, obtained by a process according to claim 1.

11. A mineral-free and aldehyde-free high thermal stable organic leather having Ts >100° C. and suitable for shoe production, obtained by a process according to claim 1.

12-14. (canceled)

15. Automotive seating covers prepared from leather as claimed in claim 10.

16. Automotive seating covered with leather as claimed in claim 10.

17. Footwear uppers prepared from leather as claimed in claim 11.

18. Footwear with uppers prepared from leather as claimed in claim 11.

19. A process according to claim 2 in which trigycidyl isocyanurate is used as the tanning compound.

20. A process according to claim 3 in which trigycidyl isocyanurate is used as the tanning compound.

21. A process according to claim 4 in which trigycidyl isocyanurate is used as the tanning compound.

22. A process according to claim 2 in which the tanning compound is a urea adduct of the poly(glycidylamine).

23. A process according to claim 3 in which the tanning compound is a urea adduct of the poly(glycidylamine).

24. A process according to claim 4 in which the tanning compound is a urea adduct of the poly(glycidylamine).

25. A process according to claim 5 in which the tanning compound is a urea adduct of the poly(glycidylamine).
